(19) United States
(12) Patent Application Publication
(10) Pub. No.: US 2010/0126695 A1
(43) Pub. Date: May 27, 2010

(54) 3-In-1 Portable Beverage Chiller and Warmer

(75) Inventor: Steve Gara, Cooper City, FL (US)

Correspondence Address: Steve Gara, 2838 Cayenne Avenue, Cooper City, FL, 33026, US

(73) Assignee: Steve Gara, Cooper City, FL (US)

(21) Appl. No.: 12/276,457

(22) Filed: Nov. 24, 2008

(51) Int. Cl. F25B 29/00; H05B 3/68

(52) U.S. Cl. 165/58; 219/443.1

(57) ABSTRACT

A portable device/appliance for cooling and heating beverages on a center circular metallic object/pad. The appliance body is of square shape made of hard plastic with a circular metallic pad that includes an assembly that heats and cools beverages with the help of a switch. It has an electrical means by plug/adapter for connecting to a source of direct current and for enabling the polarity of the direct current provided to be reversed so that the device can either heat or cool the beverage container that is placed on the circular metallic object/pad. It also has the ability to heat and cool beverages by battery and by USB cable connected to a PC/Computer with a USB outlet. These 3 ways of power give the device it's portability. The fact that it operates via battery power also makes it a true portable device.

This invention relates generally to cooling/heating apparatus and more particularly to portable devices that are able to have a means for heating or cooling beverage containers and the liquids therein. The reference herein as to “unit” or “device” will be interchangeably used but will refer to the same object.

To better understand the invention, reference is made to the accompanying detailed drawing/sketch above of device:

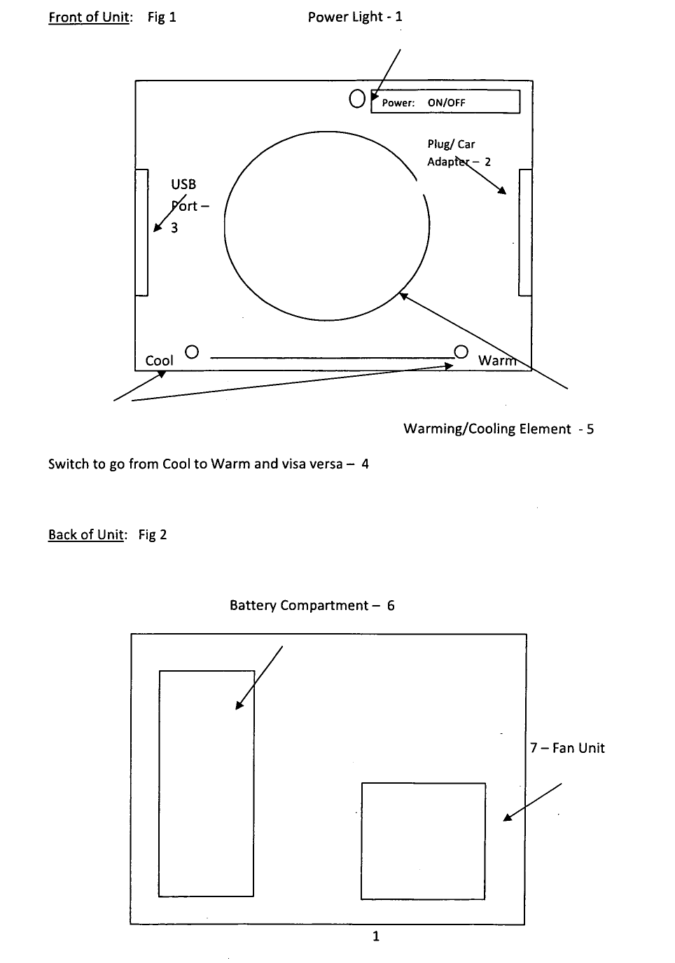

FIG. 1—Is front or top level view of device

FIG. 2—Is rear or bottom view of device

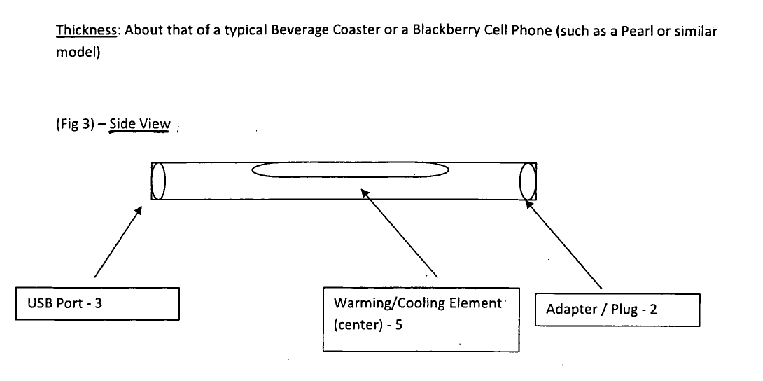

FIG. 3—Is side/vertical view of device

Referring to more detail in the drawing/sketch, in FIG. 1, it shows the body of the device which is a basic square shape and 5 shows the main circular warming and cooling element of the device itself. 1 refers to a light that shows when the unit is powered by any one of the 3 power sources (Plug/Adapter, USB or Battery power) to indicate that unit is “on.” 3 shows the USB Port that can power device via USB power from a computer. 2 illustrates an adapter/plug for use in a car or if near a conventional power source in order to operate device. 4 is a switch that moves from Cool to Warm depending on what is desired and enables element to either cool or warm a beverage depending on selection/position of switch.

FIG. 2 shows the back side view of device. 6 is the compartment for the battery power. 7 is the Fan Unit that cools the unit during operation of any of the 3 power sources.

FIG. 3 is a vertical/side view of device and shows a different view of 3, which is the USB Port, of 2 which is the plug/adapter and 5 which is the warming and cooling element for the unit.

There are no current devices/appliances that exist on the market that have 3 unique power sources, that are portable and can warm and/or cool beverages in one unit. There are devices/appliances that can warm or cool liquids but have only one power source, a USB cable source, which makes them limited in portability and therefore not suitable as such. The fact that this appliance is capable of running on battery power makes it of much more value as a portable device than a beverage warmer/cooler with only 1 source of power. This patent is for an improved and more portable type of device/appliance.

Accordingly, it is the general object of the instant invention to provide a portable means for heating or cooling beverage containers which overcomes the disadvantages of prior art of having devices with only 1 source of power.

It is still a further object of the instant invention to provide a portable unit for heating or cooling beverage containers which is simple in construction and low in cost.

The electric plug/conductor prongs (3 pronged plug that is detachable) are able to be connected to device/appliance to a suitable connector for providing direct current to the device.

In accordance with a preferred aspect of this invention direct current is provided to the unit via a conventional cord set/adapter. To that end one end of the cord set includes a conventional plug for disposition within a cigarette lighter socket in an automobile or any other suitably configured socket providing direct current. The other end of the cord set 130 includes a female receptacle receipt of the prongs.

Also in accordance with an aspect of this invention is another power source, a USB (Universal Serial Bus port) device that is capable of fitting with any standard USB port on a personal computer or laptop to provide direct current power to unit.

Also in accordance with an aspect of this invention is a battery compartment in back of unit for the operation of 2 AA sized batteries to provide temporary power to unit if it is not in contact with a direct current power source (Electric Plug or USB device).

The metallic circular pad in the center of unit contains elements under it that either can heat or cool beverage containers with the help of a switch located on exterior of unit.

There is a light that turns red if warming or blue if unit is in cool mode based on what position the switch is in.

### Operation of the Device is as Follows:

Unit use is simple and can be operated by plugging device into a personal computer USB port, using a 3 prong electric plug or car adapter or by battery power to warm or cool beverage containers. It should take device no more than 5 minutes to achieve desired temperature to heat or cool liquids within the beverage containers. It is to be safely designed so that unit does not get overly cool or hot. Once unit is powered up, simply place any beverage container on metallic center surface, put the switch in desired location for either cooling or warming of beverage.

Without further elaboration the foregoing will so fully illustrate my invention so that others may, by applying current or future acknowledge, readily adapt the same for use under various conditions of service. Variations of this invention would include a similar device to keep multiple beverages cool or warm, however this specific unit only is able to cool or warm one beverage container at a time. Also while variations changes may be made in the detail or design construction of unit, it shall be understood that such changes shall be within the spirit and scope of the present invention as defined by the claim made.

What is claimed as the invention is:

1. A small portable device/appliance for cooling or heating beverages on a center circular metallic object/pad. The appliance body is made of hard plastic with a circular metallic pad that includes an assembly that heats or cools beverages with the help of a switch. It has an electrical means by plug/adapter for connecting to a source of direct current and for enabling the polarity of the direct current provided to be reversed so that the device can either heat or cool the beverage container that is placed on the circular metallic object/pad. It also has the ability to heat and cool beverages by battery or by USB cable connected to a PC/Computer with a USB outlet. These 3 ways of power give the device it's portability.
Containers placed on metallic center can be made of any material: Glass, Metal, Ceramic, Plastic, Stoneware or similar and device can cool or warm using a switch on body of device and by using one of the 3 power sources mentioned above.
